(19) United States
(12) Patent Application Publication
(10) Pub. No.: US 2005/0215324 A1
(43) Pub. Date: Sep. 29, 2005

(54) Game system, methods and apparatus using embedded audio commands

(76) Inventor: Louis A. Lippincott, Los Altos, CA (US)

Correspondence Address: Louis A. Lippincott, 720 Anderson Drive, Los Altos, CA, 94024, US

(21) Appl. No.: 11/091,066

(22) Filed: Mar. 28, 2005

Related U.S. Application Data
(60) Provisional application No. 60/557,326, filed on Mar. 29, 2004.

(51) Int. Cl. A63F 13/00

(52) U.S. Cl. 463/43

(57) ABSTRACT

Methods and systems are described for providing a game system using standard consumer electronics equipment. For example, a system for playing games on a DVD player and other standard consumer electronics equipment transmits commands to a number of player remote units in response to commands from a game being played on the DVD player and other standard consumer electronics equipment. An electronic control mechanism translates the commands from the standard consumer electronics equipment and retransmits them to a number of player remote units. Using those commands, the game proceeds until completed.

### CROSS-REFERENCE TO RELATED APPLICATIONS

This application is related to and claims domestic priority under 35 U.S.C. §119(e) from prior U.S. Provisional Patent Application Ser. No. 60/557,326 filed on Mar. 29, 2004 entitled “Multiple Player DVD Game System, Methods, and Apparatus Using 2-Way Communications”, by inventor Lou Lippincott, the entire disclosure of which is hereby incorporated by reference as if fully set forth herein.

### TECHNICAL FIELD

This invention relates generally to electronic games and optical storage discs and more specifically to a multiple-player game that can be played back on a standard consumer electronics digital versatile disc (DVD) player.

### BACKGROUND

A number of single-player games have been developed that can be played in conjunction with standard consumer electronics, such as DVD players, stereo equipment, video recorders, media centers, DVD recorders, and other systems whose primary function is not gaming. For example, some DVD movies include short trivia games, mazes, or other simple games as features on their discs. Moreover, a number of board games have been developed that are supplemented by features displayed on standard consumer electronics equipment. For example, SceneIt? is a board game that comes with a DVD containing scenes from popular movies and television programs. During the game, players watch scenes from the DVD and take turns trying to identify the shows being played. The consumer electronics equipment is used to enhance gaming and entertainment environments.

One of the major drawbacks to current game systems using standard consumer electronics is that they do not allow multiple players to concurrently interact with them in any substantive way within the context of a multi-player game. For example, in the game SceneIt? the DVD player only shows program clips and must be controlled by the one DVD remote control. The DVD portion of the game provides no meaningful action in the game for the players that do not have possession of the DVD remote control. This is in spite of the popularity and low cost of the standard consumer electronics DVD player and its typical location in the home.

The large installed base of standard consumer electronics DVD players should make the DVD player device an attractive choice for game developers. But, currently, the inability to have truly interactive multiple-player games is seen as a hindrance to the large scale acceptance of the standard consumer electronics DVD player as a central game machine in the home. Furthermore, the large installed base of standard consumer electronics DVD players have their included functionality and modes of operation that limit what can be done for games and other uses besides watching movies. There exists a significant problem in that whatever methods are used to extend the capabilities of the DVD player must be compatible with the large installed base of standard consumer electronics DVD players.

Thus, there is a need in the art for methods, systems, and apparatuses that provide an environment in which multiple players can play a game using a standard consumer electronic device.

### SUMMARY

Methods and systems are presented herein for providing a multi-player game system using standard consumer electronics equipment.

According to a first aspect, a system for playing multi-player games on a digital versatile disc (DVD) player and other standard consumer electronics equipment sends commands to player remote units in response to challenges or questions from a game being played on the DVD player and other standard consumer electronics equipment. An electronic control mechanism converts commands embedded in the audio track of the DVD game in to wireless commands understood by the player remote units. A separate electronic control mechanism in the player remote units determines if each player's response to the challenge or question was correct. All of the player remote units check for the correct response simultaneously and provide immediate and simultaneous feedback to all of the players in the game.

According to a second aspect, a method for configuring the player remote units before or during a DVD-based game is provided. The DVD disc itself is encoded with audio commands and visual data that is associated with each of the game configuration parameters.

Additional features and advantages of the invention will be made apparent from the following detailed description of embodiments that proceeds with reference to the accompanying drawings.

### BRIEF DESCRIPTION OF THE DRAWINGS

Embodiments may be best understood by referring to the following description and accompanying drawings. In the drawings:

FIG. 1 illustrates a simplified block diagram of a system configuration that includes a DVD Game Disc, DVD player, Television, DVD Remote Control, DVD Multiple Player Device, and four Player Remote Units, according to embodiments.

FIG. 2 illustrates a more detailed block diagram of a DVD Multiple Player Device unit, according to embodiments.

FIG. 3 illustrates a more detailed block diagram of a Player Remote Unit, according to embodiments.

FIG. 4 illustrates a waveform of an embedded audio command preamble example, according to embodiments.

FIG. 5 illustrates an example Game Challenge for the game players, according to embodiments.

FIG. 6 illustrates a flowchart illustrating a technique for detecting and sending an embedded audio command to the Player Remote Units for a multi-player game using standard consumer electronics equipment.

FIG. 7 illustrates a sample set of embedded audio commands, according to embodiments.

FIG. 8 illustrates a Player Remote Unit, according to embodiments.

### DETAILED DESCRIPTION

Methods, apparatuses, and systems for a multiple-player game architecture are described. In the following description, numerous specific details are set forth. However, it is understood that embodiments may be practiced without these specific details. In other instances, well-known circuits, structures, and techniques have not been shown in detail in order not to obscure the understanding of this description. While described with reference to playing multiple-player games, specifically, four players on a digital versatile disc (DVD) player, embodiments are not so limited. For example, embodiments include the playing of games with any number of players. For another example, embodiments include the playing of games on a DVD recorder, personal video recorder, media center, etc. Embodiments also include playing and controlling the playback of content other than games, such as training material, audio visual aids, etc.

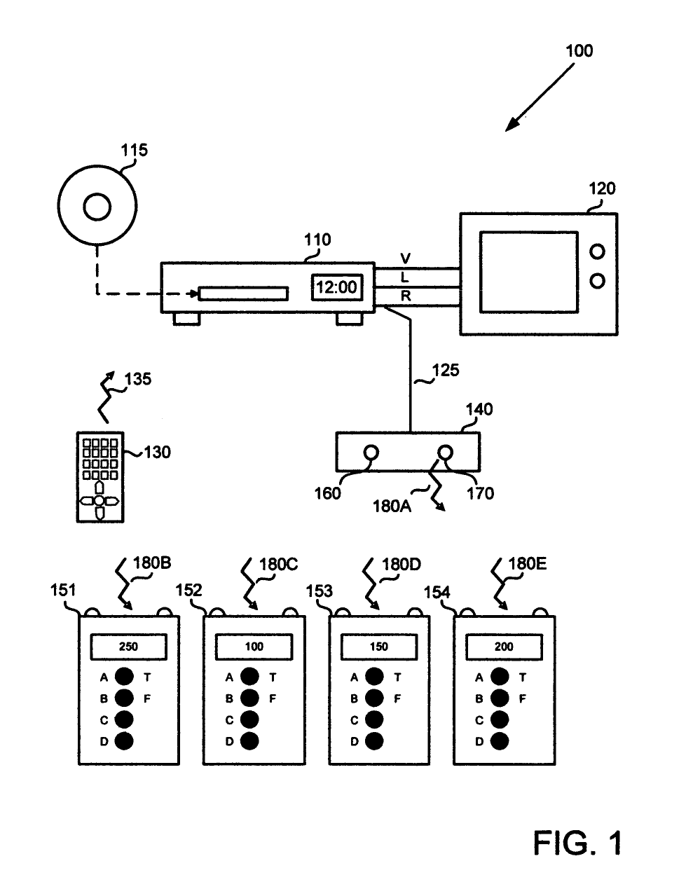

FIG. 1 illustrates a simplified block diagram of a system configuration 100 for playing multi-player games on standard consumer electronics systems. As shown, FIG. 1 illustrates a system 100 that includes a DVD Game Disc 115, DVD Player 110, Television 120, DVD Remote Control 130, DVD Multiple Player Device 140, and four Player Remote Units 151, 152, 153, and 154. The DVD Player 110, Television 120, and DVD Remote Control 130 are standard consumer electronics devices. For example, the Television 120 includes any of a number of different viewing devices, such as high-definition television, plasma screen television, other types of television sets, computer monitors, etc. Similarly, the DVD Player 110 includes a DVD player, a DVD recorder, a media Center, a personal video recorder, etc.

In some embodiments, the DVD Player 110 is coupled to the DVD Multiple Player Device 140 through one of the Left or Right audio channel outputs through a “Y” cable 125, providing simultaneous audio information to the TV 120 and the DVD Multiple Player Device 140.

The DVD Game Disc 115 containing game content is inserted into the DVD Player 110, which is coupled to the Television 120. The DVD Remote Control 130 transmits signals 135 to the DVD Player 110. The four Player Remote Units 151, 152, 153 and 154 receive signals 180B, 180C, 180D, 180E from the signal 180A transmitted by the DVD Multiple Player Device 140. In some embodiments, the signals 135, 180B, 180C, 180D, 180E, 180A are Infra Red (IR) signals. Alternatively, they may be a different signal, e.g., radio frequency, microwave, or other wireless signal. In some embodiments, the Player Remote Units 151, 152, 153 and 154 are coupled to the DVD Multiple Player Device 140 through a cable.

The transmitted signals 135 send commands to the DVD Player 110. The DVD Player receives those commands. The DVD Multiple Player Device 140 sends commands to the four Player Remote Units 151, 152, 153 and 154 and, in some embodiments, the DVD Player 110.

The DVD Multiple Player Device 140 has an LED display 160 to indicate states and conditions of the game to the players. The DVD Multiple Player Device 140 has an IR LED 170 to send commands to the Player Remote Units 151, 152, 153 and 154. Notably, the number of IR LED's on the DVD Multiple Player Device may be more or less based on functional design, aesthetic design, area to be covered by transmitted commands, the number of players the device is designed for, size of the device, cost, etc.

In some embodiments, game modes are configured before the game play starts by sending commands to the Player Remote Units 151, 152, 153 and 154 from the DVD Multiple Player Device 140. The game modes define the game pace, patterns of game challenges, game conclusion criteria, game scoring criteria, the maximum game challenges on the DVD Game Disc 115, and other aspects of the game not described herein.

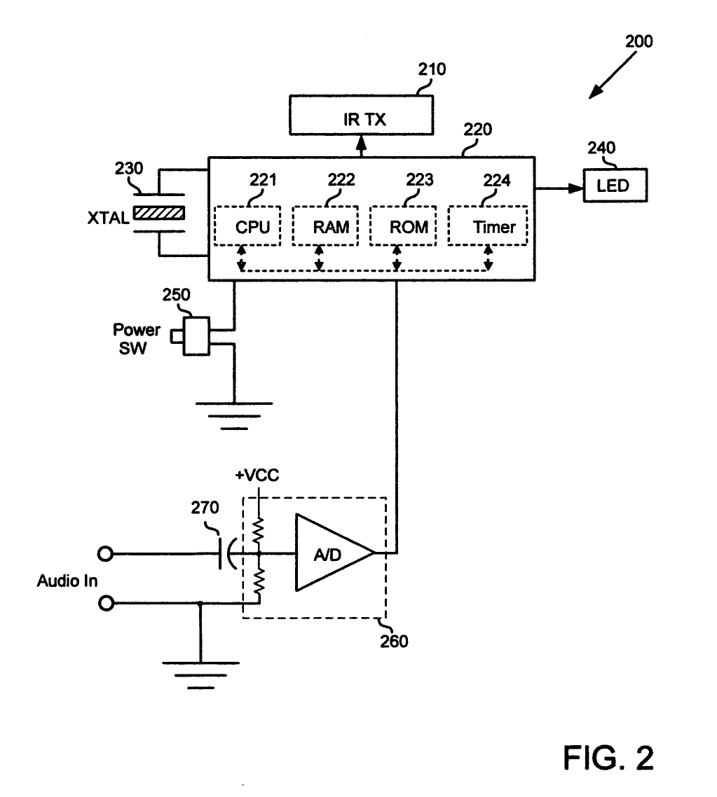

FIG. 2 illustrates a simplified block diagram of a DVD Multiple Player Device 200, which receives audio signals from the DVD Player and sends commands to the Player Remote Units. For example, a DVD Player causes a trivia question to be displayed on a Television; the players enter their guess at the correct answer into their Player Remote Unit's keypad. After a predetermined delay, according to the authoring of the DVD Game Disk 115, the DVD Player sends an embedded audio command to the DVD Multiple Player Device. The DVD Multiple Player Device converts the audio command to an IR command understandable by the Player Remote Units and transmits the command through its IR Transmitter 210. The Player Remote Units receive the command and interpret the command for a specific action. In some implementations, the command could be one that describes the correct answer for the trivia question and the specific action by the Player Remote Units may be to blink a red LED if the player guessed wrong and blink a Green LED if the player guessed correctly. This can be done without ever revealing the correct answer to the players that guessed wrong, according to embodiments.

As shown, FIG. 2 illustrates an exemplary configuration of a DVD Multiple Player Device 200 that includes an Electronic Control Mechanism 220, comprising a CPU 221 coupled to RAM 222, ROM 223 and at least one Timer 224, an IR Transmitter 210, an audio Analog to Digital converter 260, Clock timing device 230, Power Switch 250, audio coupling capacitor 270, and LED 240. Alternatively, the device may use other components, for example, it may use an RF transmitter, a reset switch, an RF receiver, etc.

The Electronic Control Mechanism 220 processes received signals and commands received from the DVD Player. The Clock timing device 230 is used to provide a predictable timing source and clock to the CPU 221. The Clock timing device 230 may be a crystal timing device, a ceramic resonator timing device, a ring oscillator device, or a resistor/capacitor timing device. The Clock timing device 230 may be integrated with the CPU 221 device as a timing source that is accurate enough to time the commands for the IR Transmitter 210. In some embodiments, the Clock timing device 230 runs at a rate of 4 MHz. Alternatively, it may run at a slower or a faster rate, for example, at 1 MHz or 10 MHz. The IR Transmitter 210 is used to send commands to a number of Player Remote Units, such as the Player Remote Units 151, 152, 153 and 154 illustrated in FIG. 1. The audio A/D 260 is used by the DVD Multiple Player Device 140 to receive commands from a DVD Player such as the DVD Player 110 illustrated in FIG. 1.

In some embodiments, the audio A/D 260 is a simple one-bit analog to digital converter and can be comprised of an amplifier and clipper to provide a digital signal to the Electronic Control Mechanism 220. In some embodiments, the audio A/D 260 is a simple one-bit analog to digital converter and can be comprised of a voltage comparator to provide a digital signal to the Electronic Control Mechanism 220.

In some embodiments, the audio A/D 260 is an integrated component containing the needed circuits in one small, inexpensive module. Alternatively, they may be separate or a combination thereof. In some embodiments, the audio A/D 260 is integrated in the Electronic Control Mechanism 220.

In some embodiments, the Power Switch 250 is used to power on and initialize the DVD Multiple Player Device 200 to a known state. Alternatively, the device could use so little power as to not need a power on/off switch. In some embodiments, the Power Switch 250 may also be used to abort a game in progress. Alternatively, a separate reset switch may perform this function.

The LED 240 is used to give immediate feedback to players from the DVD Multiple Player Device 200. For example, DVD Multiple Player Device 200 signals when the opportunity to answer the Game Challenge has expired.

In one embodiment, the DVD Multiple Player Device 200 contains a buzzer (not shown) to give an audible indication that the opportunity to answer the Game Challenge has expired.

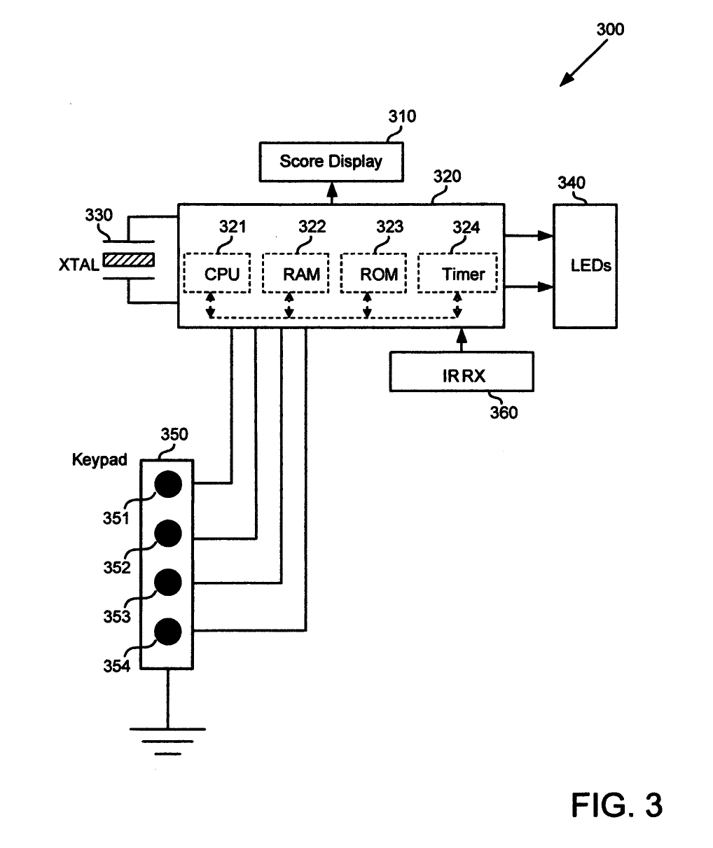

FIG. 3 illustrates a simplified block diagram of a Player Remote Unit, which allows users to interact with a DVD Multiple Player Device. As shown, FIG. 3 illustrates a Player Remote Unit 300 such as Player Remote Units 151, 152, 153 and 154 described in connection with FIG. 1. Player Remote Unit 300 includes an Electronic Control Mechanism 320, comprising a CPU 321 coupled to RAM 322, ROM 323 and at least one Timer 324, an optional Score Display 310, an IR Receiver 360, Clock timing device 330, Keypad 350 and LED 340. Alternatively, the device may use other components, for example, it may use an RF receiver, a reset switch, etc.

The Electronic Control Mechanism 320 processes signals and commands received from the DVD Multiple Player Device. The Clock timing device 330 is used to provide a predictable timing source and clock to the CPU 321. The Clock timing device 330 may be a crystal timing device, a ceramic resonator timing device, a ring oscillator device, or a resistor/capacitor timing device. The Clock timing device 330 may be integrated with the CPU 321 device as a timing source that is accurate enough to time the commands for the IR Receiver 360. In some embodiments, the Clock timing device 330 runs at a rate of 4 MHz. Alternatively, it may run at a slower or a faster rate, for example, at 1 MHz or 10 MHz. The IR Receiver 360 is used to receive commands from the DVD Multiple Player Device, such as the DVD Multiple Player Device 140 illustrated in FIG. 1.

In one embodiment, the Player Remote Unit 300 contains a Keypad 350 with four keys or buttons. Notably, the Player Remote Unit may include more or less keys based on functional design, aesthetic design, etc. The keys generally correspond to answers for the Game Challenge being presented to the players. For example, the first key 351 may correspond to the first answer choice on the screen or a “True” response. The second key 352 may correspond to the second answer choice on the screen or a “False” response. The third key 353 may correspond to the third answer choice on the screen and the fourth key 354 may correspond to the fourth answer choice on the screen. In one embodiment, the keys on the keypad also serve to wake up the Electronic Control Mechanism 320 from a very low power sleep state, negating the need for a power switch.

When the player pushes a key on the Keyboard 330, the Electronic Control Mechanism 320 remembers the key that was pressed. When an IR command is received that instructs the Electronic Control Mechanism 320 to validate the key that was pressed with the correct answer identified by the IR command, the Electronic Control Mechanism 320 compares the key that was pressed with the correct answer and responds accordingly. In one embodiment, the Electronic Control Mechanism 320 adds points to the total score for a correct answer and subtracts points for a wrong answer while blinking a green LED for a correct answer or blinking a red LED for a wrong answer.

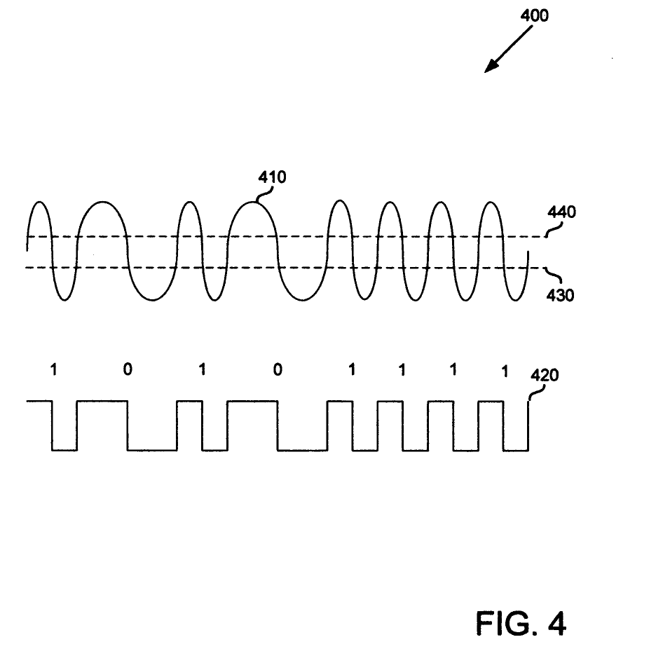

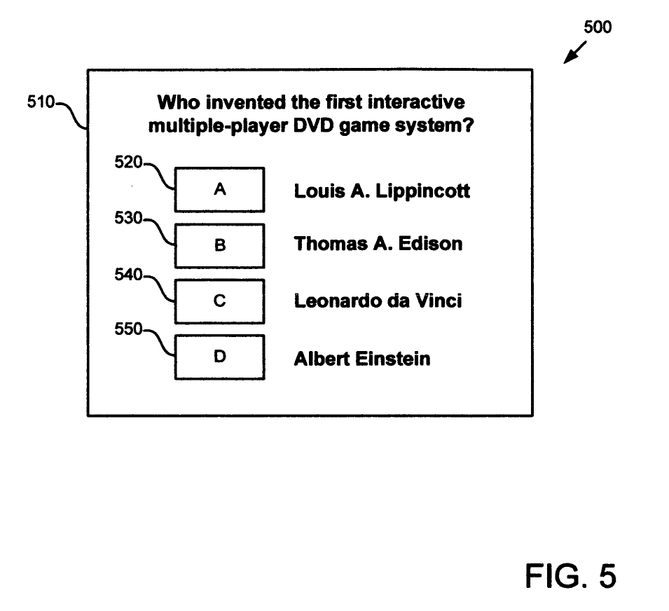

FIG. 4 illustrates an example waveform for an embedded audio command preamble. In one embodiment, the preamble serves as a filter to eliminate false detections of embedded audio commands. In other words, the likelihood that an audio track would contain the exact waveform of the preamble is minimal. The likelihood is reduced even further by using a loud (high amplitude signal) waveform for the preamble and command. For example, the DVD Multiple Player Device might ignore all audio signals that are between the thresholds 440 and 430 set by the analog to digital converter. The audio reproduction capability of even the least expensive DVD players is quite good and in addition the audio is digitally encoded on the Game Disk. The combination of these techniques and the DVD player audio playback characteristics provide a very reliable and inexpensive way to get digital command information from the DVD player to the DVD Multiple Player Device.

In one embodiment, the preamble waveform 410 is encoded by using a higher frequency to represent digital ones and a lower frequency to represent digital zeros. The higher frequency for ones could be 2000 Hz and the lower frequency for zeros could be 1000 Hz. Notably, the choices for the frequencies could be different than the choices described.

The audio waveform 410 is fed to the single-bit analog to digital converter in the DVD Multiple Player Device. The digital waveform 420 is the output of the analog to digital converter and is the binary sequence that is analyzed for pattern and timing by the Electronic Control Mechanism in the DVD Multiple Player Device. In one embodiment, the preamble is a binary string of eight digits in the pattern of 10101111, as shown by the digital waveform 420, followed immediately by the eight bits of the audio command (not shown, but encoded using the same techniques), followed in turn by a dummy one bit to end the waveform (also not shown). Notably, the choices for the preamble bit patterns and the number of bits in the command could be different than the choices described.

The frequency choices and bit patterns described above result in very short bursts of audio for the embedded audio commands. The total time for an embedded audio command is in the range of only 15 milliseconds. The result is a very short beep or blip heard by the players and reduces the annoyance factor for embedding commands in the audio track of the DVD Game Disk. An alternative would be to use DTMF commands in the audio track, but DTMF decoding is much more complicated and requires longer bursts of audio signals.

FIG. 5 illustrates a simplified block diagram of a Game Challenge configuration that may include several features such as an introduction, rules review, menu buttons, etc. As shown, FIG. 5 illustrates a diagram of a Menu Configuration 500 that includes a Game Challenge Audio-Video Content 510, and four answer choices 520, 530, 540, and 550. The Game Challenge Audio-Video Content 510 may have more or less buttons depending on game options, complexity of the game, and other such factors.

The First Play (not shown) is an audio/video sequence that is automatically played by a DVD Player when a DVD Game Disc is first inserted. The First Play generally ends with a transition to a top level menu, also not shown. In some embodiments, the First Play contains the game preparation steps, rules of the game and a description of the game play. The First Play may also contain advertisements for additional DVD Discs that can be played with a DVD Multiple Player Device system. In some embodiments, a game is started by a person making a selection from the top level menu (not shown) as is usually done with DVD movies. The authoring of the First Play sequence and the top level selection menus is well known in the industry and providing further details is beyond the scope of this description.

After the First Play, a DVD Game Disc presents a Game Challenge in the form of an audio/video sequence, a still picture menu or motion menu like the one shown in FIG. 5. A Game Challenge includes the actual steps, theories, interactive content, and events that are associated with playing a game. For example, in a trivia game, the Game Challenge is a question presented to users on a Television.

As mentioned, the Menu Configuration 500 contains the playback of a video and audio sequence representing the Game Challenge. Or, it is simply a still menu with text asking a question or presenting some other type of Game Challenge. DVD discs can be authored in a manner that allows a DVD Player to select Game Challenges at random or select Game Challenges according to the play of the game or based on previous responses from the players. Several examples of sophisticated DVD games exist in the market already and the methods of authoring such a disc are well known and beyond the scope of this description. However, in order for the DVD game disc to play in a predictable manner with a DVD Multiple Player Device the DVD Game Disc must be authored with aspects of a DVD Multiple Player Device and Player Remote Units behaviors considered.

In one embodiment, the DVD Game Disc presents a Game Challenge to the players, an example being the “Who invented the first interactive multiple-player DVD game system?” Game Challenge shown in FIG. 5, followed by an embedded audio command after a short delay. The delay gives each player time to lock in their choice for the correct answer. The embedded audio command would indicate to the Player Remote Units which answer is correct (e.g. answer “A” in this example).

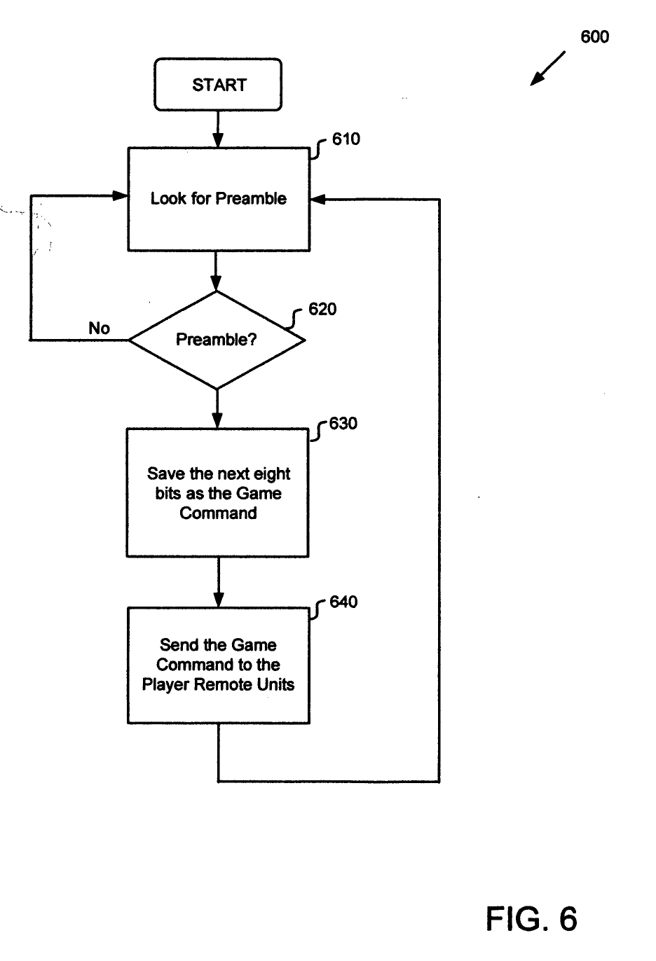

FIG. 6 illustrates a flow diagram giving a more detailed description of the operation of a DVD Multiple Player Device such as the DVD Multiple Player Device 140 shown in FIG. 1. In some embodiments, when the device is not being used it remains in a powered off state, consuming very little power. In other words, the DVD Multiple Player Device has powered down all components that are not needed.

The user powers on the device by pressing a Power Switch. As a result, the DVD Multiple Player Device transitions through the START condition and starts looking for the preamble of the embedded audio command 610.

When a DVD Multiple Player Device detects a preamble of the embedded audio command it will decode and save the next eight bit patterns from the audio command 630. The DVD Multiple Player Device will then transmit the decoded audio command 640 to the Player Remote Units. The DVD Multiple Player Device will then return to the Look for Preamble state 610 and wait for the next embedded audio command.

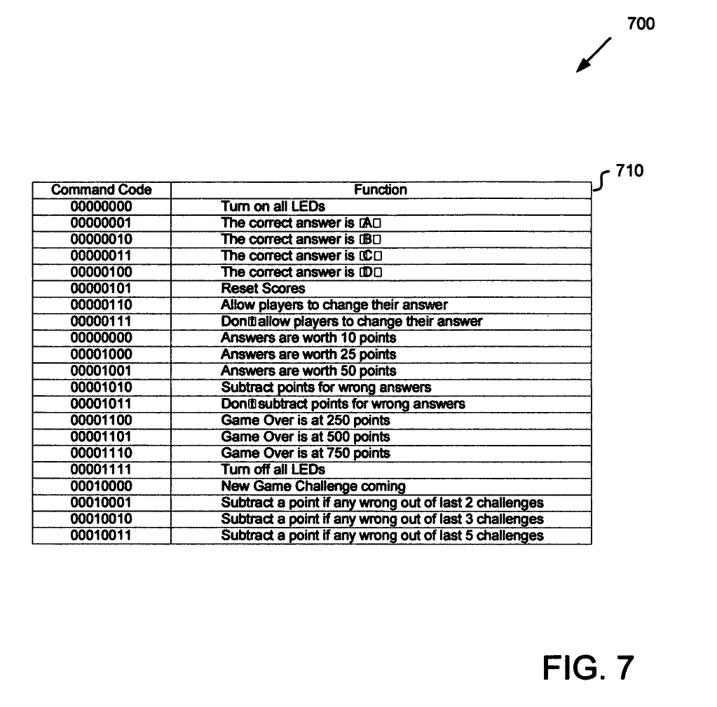

FIG. 7 shows a table of possible command codes that could be used by the Player Remote Units. The table shows only twenty or so of the two hundred and fifty six possible commands that could be generated by using an eight-bit audio command. The commands shown are self explanatory or specific to a type of game that could be developed for the invention. Notably, many commands could be added or modified to suit the play of the game that would be provided on the DVD Game Disk. In one embodiment, some commands are used during game play, such as “The correct answer is ‘A’” and “New Game Challenge coming”, while some commands are used to configure the game play before the game starts. For example, “Subtract points for wrong answers” and “Don't allow players to change their answer” may make the game more difficult to master in fast paced games. Separately accessed DVD menus could be used to configure the game play before the game starts.

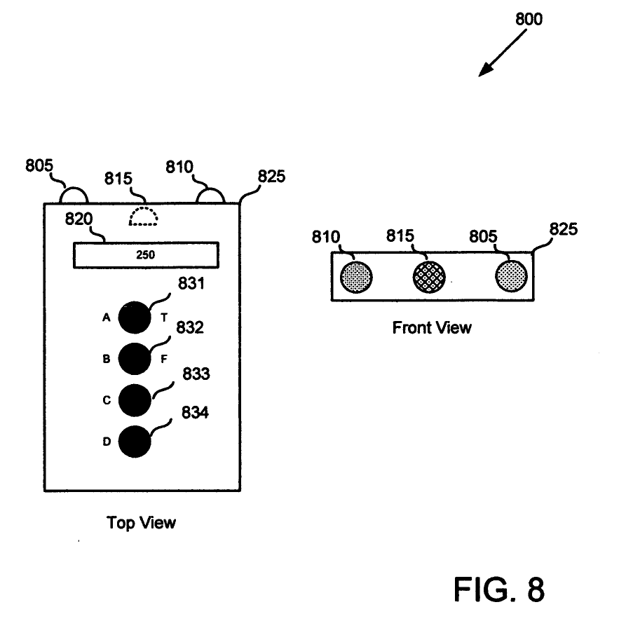

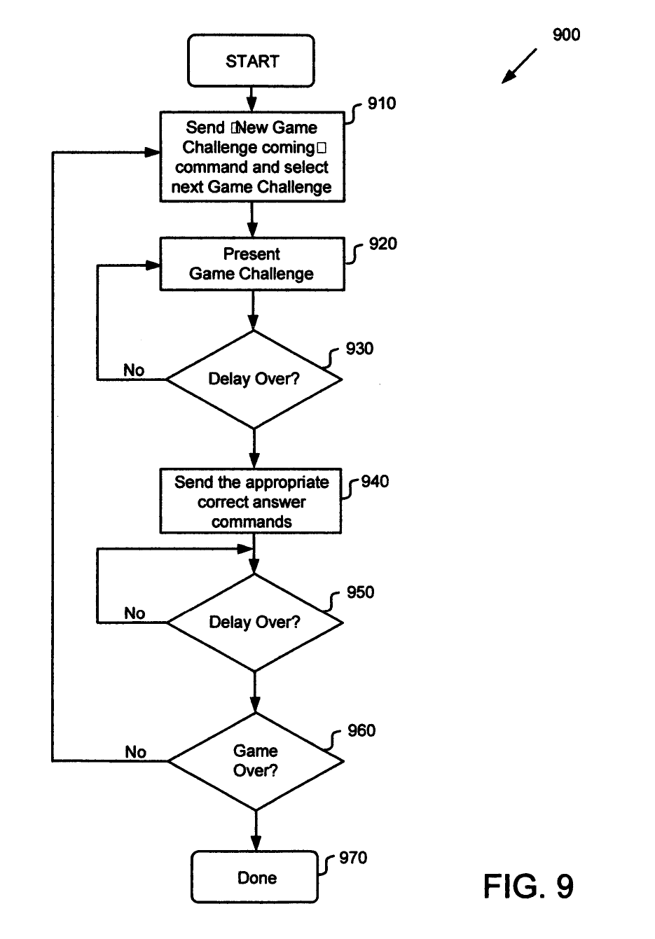

FIG. 8 illustrates a Player Remote Unit. In one embodiment, the Player Remote Unit 825 contains a red LED 805, green LED 810, IR Receiver 815, Score Display 820 and a Keypad containing a key for “A” and “True” answers 831, a key for “B” and “False” answers 832, a key for “C” answers 833 and a key for “D” answers 834. In one embodiment, the IR Receiver 815 is recessed behind a dark plastic window in order to pass only infrared light. Notably, the Player Remote Unit may contain different keys on the Keypad, may use different numbers and colors of LEDS and may use different techniques for showing the current score.

FIG. 9 illustrates a flow diagram giving a more detailed description of the operation of a DVD Game Disk. In one embodiment, the DVD Game Disk would, after the setup and configuration by the players and starting game play, send a “New Game Challenge coming” command to the Player Remote Units and select the next Game Challenge (step 910) to be played back on the DVD Player. The Game Disk would then cause the DVD Player to present the next Game Challenge 920 to the players, an example being the one shown in FIG. 5. At this point each player would be entering in their guess at the correct answer on their Player Remote Unit. After a predetermined delay 930 the Game Disk would then cause the DVD Player to send embedded audio commands to the DVD Multiple Player Device (step 940) which would then send the commands in a wireless form to the Player Remote Units. As previously described, the embedded audio commands are specific audio waveforms in the audio track of the Game Disk content. In one embodiment, the embedded commands include an indication of the correct answer and how to respond to the players guess, flashing LEDs and/or increasing or decreasing their score. The Player Remote Units would respond accordingly, depending on whether the player guessed correctly or not. In one embodiment, the Game Disk would then cause the DVD Player to delay long enough for the players to react to the response of each of the Player Remote Units (step 950). Some game plays may have penalties beyond what the Player Remote Units indicate and may include a set of penalty cards to be used against the only player to guess incorrectly. In another embodiment, the Game Disk would cause the DVD Player to delay (step 950) barely long enough for the players to get ready for the next Game Challenge, for a much faster paced game. After this delay (step 950), the Game Disk would cause the DVD Player to check to see if the game has reached its predetermined end point (step 960) and would return to step 910 if the game is to continue. In one embodiment, the Game Disk would cause the end of the game by reaching a predetermined end point, such as ten Game Challenges have been presented. In another embodiment, the Game Disk would continue to present Game Challenges until a player instructs the DVD Player to end the game through the use of the DVD Remote Control 130 shown in FIG. 1.

In view of the wide variety of permutations to the embodiments described herein, this detailed description is intended to be illustrative only, and should not be taken as limiting the scope of the invention. To illustrate, while operations have been described with reference to a DVD Multiple Player Device, embodiments are not so limited. For example, in an embodiment, the functionality of a DVD Multiple Player Device can be embodied in the DVD Player. Moreover, while described with reference to the playing of games, embodiments are not so limited. For example, in one embodiment, the DVD Disc can be authored as training or learning device. Therefore, the specification and drawings are to be regarded in an illustrative rather than a restrictive sense.

1. A system for playing games in combination with standard consumer electronics equipment, the system comprising:
a receiver to receive commands from said standard consumer electronics equipment;
an electronic control mechanism for detecting commands from said standard consumer electronics equipment and translating the commands to commands compatible with and understandable by remote electronics equipment; and
a transmitter to send the set of compatible commands to said remote electronics equipment from said electronic control mechanism.

2. The system of claim 1 wherein said electronic control mechanism comprises:
a central processing unit to process said commands received from said standard consumer electronics equipment;
a random access memory for temporary storage of said commands received from said standard consumer electronics equipment coupled to said central processing unit;
a read only memory for permanent storage of instructions and parameters coupled to said central processing unit; and
a timer coupled to said central processing unit.

3. The system of claim 1 wherein said commands from said standard consumer electronics equipment occur during the playback of audio and video information encoded on an optical disk.

4. The system of claim 1 wherein said commands from said standard consumer electronics equipment are information contained in the audio output from said standard consumer electronics equipment.

5. The system of claim 1 wherein said transmitter is an infra red transmitter.

6. The system of claim 1 wherein said receiver contains an analog to digital converter.

7. The system of claim 1 wherein said standard consumer electronics equipment comprises a Digital Versatile Disc player.

8. The system of claim 1 further comprising a number of light emitting diodes to indicate a state or condition of said electronic control mechanism.

9. The system of claim 1 wherein said electronic control mechanism comprises a state machine, wherein said state machine comprises:
a first state to receive a preamble to a command; and
a second state to receive command information following said preamble.

10. A method for authoring an optical disk for the purpose of playing a game by the use of a standard consumer electronics digital versatile disc (DVD) player, the method comprising:
presenting a game challenge from said standard consumer electronics digital versatile disc (DVD) player to a number of players; and
providing a number of commands transmitted from said standard consumer
electronics digital versatile disc (DVD) player indicating the correct answer to
said game challenge to a number of player remote units.

11. The method of claim 10 wherein said game challenge contains a set of selections for the correct response to said game challenge.

12. The method of claim 10 wherein said set of selections for the correct response to said game challenge correspond to possible input responses on a player remote unit.

13. The method of claim 10 wherein said commands from said standard consumer electronics digital versatile disc (DVD) player are information contained in the audio output from said standard consumer electronics digital versatile disc (DVD) player.

14. The method of claim 10 wherein providing a number of commands transmitted from said standard consumer electronics digital versatile disc (DVD) player comprises:
navigating a set of menus on the DVD player, wherein said set of menus display aspects of a game; and
sending the set of subsequent signals based on the aspects of the game displayed by the set of menus on the Digital Versatile Disc (DVD) player.

15. A system for playing games in combination with standard consumer electronics equipment, the system comprising:
a transmitting device to translate and retransmit commands from said standard consumer electronics equipment; and
a receiving device to receive said retrnsmitted commands.

16. The system of claim 15 wherein said standard consumer electronics equipment comprises a Digital Versatile Disc (DVD) player.

17. The system of claim 15 wherein said receiving device comprises:
a receiver to receive commands from said transmitting device;
an electronic control mechanism for detecting commands from said transmitting device;
a keypad to enter responses to game challenges; and
a display device to give visual feedback to a number of players.

18. The system of claim 15 wherein said electronic control mechanism comprises:
a central processing unit to process said commands received from said standard consumer electronics equipment;
a random access memory for temporary storage of said commands received from said standard consumer electronics equipment coupled to said central processing unit;
a read only memory for permanent storage of instructions and parameters coupled to said central processing unit; and
a timer coupled to said central processing unit.

19. The system of claim 15 wherein said receiver is an infra red receiver.

20. The system of claim 15 further comprising a number of light emitting diodes to indicate a state or condition of said electronic control mechanism.
